(19) United States
(12) Patent Application Publication
(10) Pub. No.: US 2024/0043211 A1
(43) Pub. Date: Feb. 8, 2024

(54) REFRIGERATION RACK CART

(71) Applicant: B-O-F Corporation, Aurora, IL (US)

(72) Inventors: Derek Au, Aurora, IL (US); Howard Topping, Barrington, IL (US)

(21) Appl. No.: 18/228,428

(22) Filed: Jul. 31, 2023

Related U.S. Application Data
(60) Provisional application No. 63/396,130, filed on Aug. 8, 2022.

(51) Int. Cl. B65G 1/10; B62B 3/00; B62B 5/06; B62B 5/04

(52) U.S. Cl. CPC B65G 1/10; B62B 3/002; B62B 5/06; B62B 5/0495; B62B 3/104

(57) ABSTRACT

A low-profile storage cart system for convenient storage and accessibility of heavy and bulky objects such as beer kegs in refrigerated environments. The low-profile storage cart system including a securement mechanism having a proximate end and a distal end. The securement mechanism is made of at least one rail, at least one rolling surface disposed the rail, at least one guide surface disposed adjacent to the rolling surface, and at least one stop disposed on the rolling surface. The low-profile storage cart may also include a carrying surface, at least one wheel configured to engage the securement mechanism, and a control arm disposed perpendicular to the carrying surface.

### CROSS-REFERENCE TO RELATED APPLICATION

This application claims the benefit of the filing date of U.S. Provisional Patent Application No. 63/396,130, filed Aug. 8, 2022. The contents of U.S. Provisional Patent Application No. 63/396,130 is hereby incorporated by reference in its entirety.

### FIELD OF THE INVENTION

This application relates generally to carts for moving items, and more particularly, to refrigeration rack carts to facilitate handling and storage of large objects to be refrigerated, such as beer kegs.

### BACKGROUND

In many situations, inventory is stored on shelves in warehouses and stockrooms. In some such situations, the shelves can be specially designed to store the product, and the shelves provide minimal clearances around the shelved product. As a result, by reducing the clearance around the product, the warehouse or stockroom is able to maximize the amount of inventory that can be stored.

In one such example, inventory may include metal kegs. Kegs are large, heavy cylindrical containers used to store a carbonated liquid such as beer. A full keg (sometimes referred to as a half barrel) is nearly 2 feet tall and more than 16 inches in diameter. These kegs can hold approximately 15.5 gallons of beer. When empty a full keg may weigh 30 pounds (lbs) but could weigh as much as 160 lbs when filled with beer. As a result, it can be difficult to handle and stock kegs in small spaces within a refrigerated space. Although a keg typically comes with built-in handles, it is still difficult to lift and transfer a keg from shelf storage and/or the floor to a cart, dolly, or pallet.

### SUMMARY

In one aspect, the present disclosure provides a low-profile storage cart system for refrigerated storage systems. The low-profile storage cart system includes a securement mechanism having a proximate end and a distal end. In some examples, the securement mechanism includes at least one rail, at least one rolling surface disposed the rail, at least one guide surface disposed adjacent to the rolling surface, and at least one stop disposed on the rolling surface. The low-profile storage cart system may also include a low-profile storage cart including a carrying surface, at least one wheel configured to engage the securement mechanism, and a control arm disposed perpendicular to the carrying surface.

In some variations, the wheel is configured to engage the rolling surface. Additionally, the guide surface may be disposed perpendicular to the rolling surface from the proximate end to the distal end, the guide surface configured to retain the wheel on the rolling surface. Further examples include the stop disposed perpendicular to the rolling surface and configured to inhibit longitudinal movement of the wheel.

In other variations, the low-profile storage cart system includes a first rail and a second rail, the first rail including a first rolling surface and a first guide surface and the second rail including a second rolling surface and a second guide surface. Accordingly, the low-profile storage cart includes a first wheel configured to engage the first rolling surface and a second wheel configured to engage the second rolling surface.

In another aspect, the present disclosure provides a low-profile storage cart system for a refrigeration storage system. The low-profile storage cart system includes a securement mechanism having a proximate end and a distal end. The securement mechanism may also include a first rail and a second rail. Additionally, the low-profile storage cart system may also include a low-profile storage cart having a carrying surface and at least one wheel configured to engage the securement mechanism.

In some examples, at least one of the first and second rails includes a rolling surface. Additionally, the wheel may be configured to engage the rolling surface. Also, at least one of the first and second rails includes at least one stop. In such examples, when the rolling surface is disposed along a longitudinal axis, the stop disposed on the rolling surface and configured to inhibit the wheel from moving in a direction of the longitudinal axis.

In other examples, the rolling surface includes a first rolling surface and a second rolling surface, and the low-profile cart includes a first wheel and a second wheel. The first wheel may be disposed on the first rolling surface and the second wheel may be disposed on the second rolling surface, the stop disposed between the first rolling surface and the second rolling surface.

In yet further examples, at least one of the first and second rails further includes a guide surface disposed adjacent to the rolling surface. The guide surface may be parallel to the rolling surface.

In some other examples, the low-profile storage cart includes a control arm. The example low-profile storage cart includes a proximal end and a distal end. In some such examples, the control arm may be disposed on the proximal end. Additionally, the control arm may be disposed perpendicular to the carrying surface.

### BRIEF DESCRIPTION OF THE DRAWINGS

The present disclosure may be best understood by reference to the following description taken in conjunction with the accompanying drawings, in which:

FIG. 1 is a perspective view of storage system including a storage rack and a low-profile storage cart made in accordance with the present disclosure.

FIG. 2 is an exploded view of a low-profile storage cart system including a low-profile storage cart and a securement mechanism.

FIG. 3 is a partial side view of the low profile storage cart disposed in a storage state.

FIG. 4 is a partial side view of the low profile storage cart of disposed in an access state.

The figures depict preferred embodiments for purposes of illustration only and are not to scale. One skilled in the art will readily recognize from the following discussion that alternative embodiments of the systems and methods illustrated herein may be employed without departing from the principles described herein.

### DETAILED DESCRIPTION

Inventory is stored on shelves in warehouses and stockrooms. In some such situations, the stockroom shelves can be specially designed to store the product, and the shelves may provide minimal clearances around the shelved product, by minimizing clearances around the product, the warehouse or stockroom is able to maximize the amount of inventory that can be stored.

In some examples, the reduced clearance around the inventory results in some difficulties in handling inventory. For example, persons may have difficulty placing inventory on the shelves or taking inventory off the shelves. Lifting, handling, and manipulating heavier or larger inventory is particularly more difficult when the inventory is away from a person's body. For example, a person may have difficulty lifting inventory disposed at a back end of a storage shelf.

In accordance with the present disclosure, a low profile cart is provided to maintain high storage efficiency and also increase convenience of accessing and handling inventory stored in the shelves. The low profile cart includes a control arm so that the cart can be readily controlled between a storage state and an access state. Further, the cart can improve access to inventory stored on or near the ground, which would otherwise risk straining a person's back.

Also in accordance with the present disclosure, the low-profile cart is useful in storing and accessing kegs stored in a refrigerated environment and storage rack. Kegs can easily weigh well over 100 pounds and be exceptionally difficult to place on or under a shelf. In order to facilitate the movement of large inventory like fully weighted kegs, the low profile storage cart transfers the keg from beneath the shelf storage to a more accessible location. This system also increases the amount of kegs that can be stored because less space is needed under the shelf to reach for, manipulate, and control the kegs.

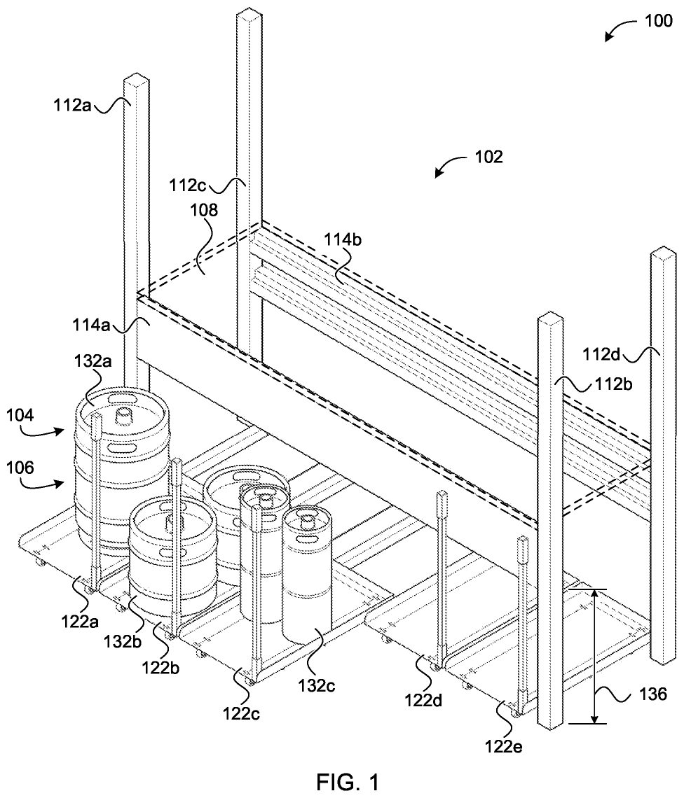

FIG. 1 illustrates a storage system 100 including a storage rack 102 and a plurality of low-profile storage carts 104 made in accordance with the present disclosure. As shown, the storage rack 102 includes a floor storage 106, but in some examples, the storage rack 102 could include an additional storage area 108. In yet other examples, the storage rack 102 may include more than one additional storage area 108.

The storage rack 102 can include any of a variety of standalone shelf units or integrated shelf units. As illustrated, the storage rack 102 includes a first, second, third, and fourth support legs 112a, 112b, 112c, 112d. Additionally, to ensure structural integrity, the storage rack 102 further includes a front brace 114a and a back brace 114b. In other examples, the storage rack 102 could include more or fewer support legs 112a, 112b, 112c, 112d and may include additional or alternative structural supports members, including structural support members known in the art to stabilize known shelf units.

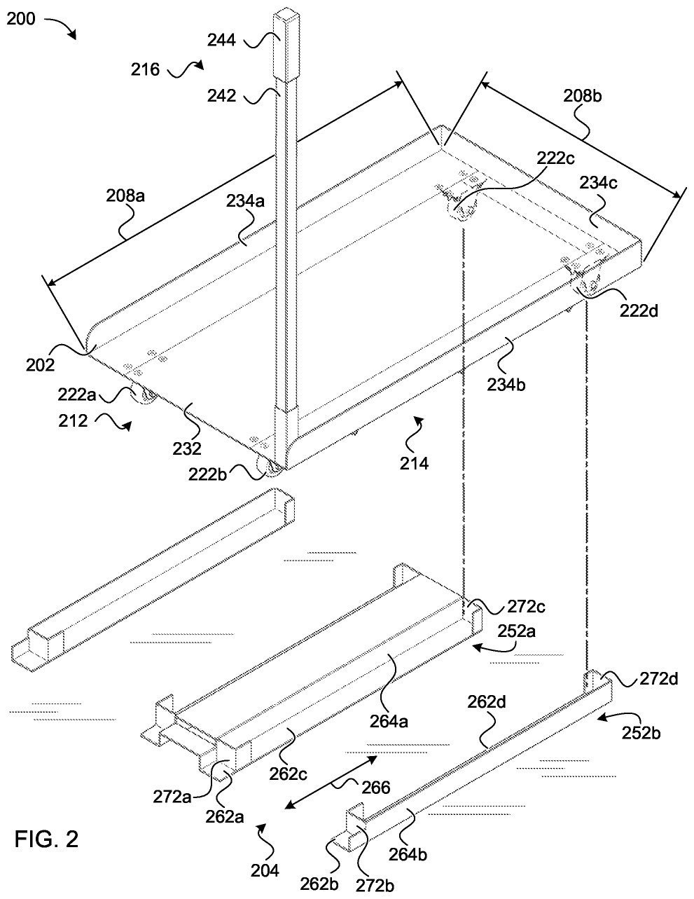

In the illustrated example, the storage system 100 further includes the plurality of low-profile storage carts 104 disposed in floor storage 106. As shown, the plurality of storage carts 104 includes a first, second, third, fourth, and fifth storage cart 122a, 122b, 122c, 122d, and 122e. An example storage cart 202 is described in greater detail in connection with FIG. 2. As shown in FIG. 1, the first storage cart 122a is carrying a first keg 132a (a half barrel), the second storage cart 122b is carrying a second keg 132b (a quarter barrel), and the third storage cart 122c is carrying a third keg 132c (a slim quarter barrel). In the illustrated example, a height 136 of the floor storage 106 is tall enough to receive the first storage cart 122a and the first keg 132a. As a result, because the first keg 132a is approximately 23.375 inches (in) tall, the first height 106 may need to be at least approximately 23.375 inches tall than the storage cart 122a carrying surface. Alternatively, the height 136 could be configured just to store the second keg 132b which is approximately 13.875 in tall. In various other examples, any of the storage carts 122a, 122b, 122c, 122d, and 122e can carry anything else and the height 134 could be adjusted to accommodate the items stored in the floor storage 106.

FIG. 2 illustrates a low-profile storage cart system 200 including the low-profile storage cart 202 and a securement mechanism 204. In the illustrated example, the low-profile storage cart 202 has a length 208a and a width 208b, and the securement mechanism 208 is sized corresponding to the size of the storage cart 202. The example storage cart 202 may have a length 208a of approximately 28 inches (in) and a width of approximately 19 in. With these dimensions, the storage cart can carry two first kegs 132a, two second kegs, 132b, or three third kegs 132c (as shown in FIG. 1). Additionally, the storage cart 202 can hold six one-sixth barrel sized kegs. However in other examples, the storage cart 202 could have a longer or shorter length and/or width.

The storage cart 202 includes wheels 212, a storage surface 214, and a handle 216. As illustrated, the wheels 212 includes casters 222a, 222b, 222c, and 222d. In other examples, the storage cart 202 could include more or fewer casters. For example, the storage cart 202 could include a fifth caster disposed centrally on the storage cart 202 to provide structural support to the storage cart 202. Additionally or alternatively, the storage cart 202 could include something other than wheels 212. For example, the storage cart 202 could include telescoping slides, rack and pinion mechanisms, pneumatic pistons, actuators configured to convert rotational motion (e.g., electric motor) to linear motion, etc.

The storage cart 202 further includes the storage surface 214. As shown, the storage surface 214 includes a flat sheet 232. As shown, the flat sheet 232 is disposed horizontally and substantially parallel to the floor. The storage surface 214 may additionally include a first side barrier 234a, a second side barrier 234b, and a rear barrier 234c. As shown, the flat sheet 232 and the first barrier, second barrier, and rear barrier 234a, 234b, 234c are formed of uniform sheets of material (e.g., metal, plastic, etc.). In other examples, the flat sheet 232 may comprise a lattice structure or grate. Similarly, the first barrier, second barrier, and rear barrier 342a, 234b, 234c could be a single rail or fencing.

The example storage cart 202 of the present disclosure may further include the handle 216. The handle 216, as shown in FIG. 2, includes a control arm 242 and a grip 244. As a result, a person could grab the control arm 242, via the grip 244, and pull and/or push the storage cart 202 between a storage state and an access state. As shown, the storage cart 202 includes only one control arm 242. In other examples, the storage cart 202 could include a second control arm 242. Additionally or alternatively, the storage cart 202 could include a different handle 216 than the control arm 242. For example, the storage cart 202 could include an electrically actuated system and the handle 216 could be a switch or electrical control mechanism. Additionally, the handle 216 could include a structure for being actuated by a person's foot.

The low-profile storage cart system 200 further includes the securement mechanism 204. The securement mechanism 204 is configured to limit movement of the storage cart 202. In the present example, the securement mechanism 204 includes a first rail 252a and a second rail 252b. Additionally, the first rail 252a and the second rail 252b are substantially identical, but mirrored. As shown in FIG. 2, the first rail 252a is configured to receive casters 222a and 222c while the second rail 252b is configured to receive casters 222b and 222d. In other examples, the securement mechanism 204 may include a first rail and a second rail that are different from each other or may include only a single rail.

The securement mechanism 204 includes a first rolling surface 262a and third rolling surface 232c disposed on the first rail 252a and a second rolling surface 262b and a fourth rolling surface 262d disposed on the second rail 252b. In some examples, the first rolling surface 232a and the third rolling surface 232c form one rolling surface and are distinguished only by the stop 272a. In other examples, the first rolling surface 232a and the third rolling surface 232c are separate components. The rolling surfaces 262a, 262b, 262c, 262d provide a smooth and level surface for the casters 222a, 222b, 222c, 222d to roll on. In some examples, the rolling surfaces 262a, 262b, 262c, 262d may include features configured to dispose the casters 222a, 222b, 222c, 222d to move in a predetermined direction or inhibit movement from a given position. For example, the rolling surfaces 262a, 262b could be inclined to cause the storage cart 202 to be predisposed towards rolling into a storage state.

The securement mechanism 204 further includes a first guide 264a disposed on the first rail 252a and a second guide 264b disposed on the second rail 252b. When the caster 222c is disposed on the first rail 252a and the caster 222d is disposed on the second rail 252b, the storage cart 202 can only be moved forward and backward along the longitudinal axis 266.

The securement mechanism 204 further includes stops 272a, 272b, 272c, 272d. The first rail 252a includes stops 272a, 272c and the second rail 252b includes stops 272b, 272d. The stop 272a is disposed adjacent the rolling surface 262a and opposite the stop 272c and stop 272b is disposed adjacent the rolling surface 262b and opposite the stop 272d. As shown, each of the stops 272a, 272b, 272c, 272d includes a vertical surface. In a preferred embodiment, the stops 272a, 272b, 272c, 272d are configured to limit movement of the casters 222c and 222d to only the rolling surfaces 262a, 262b respectively.

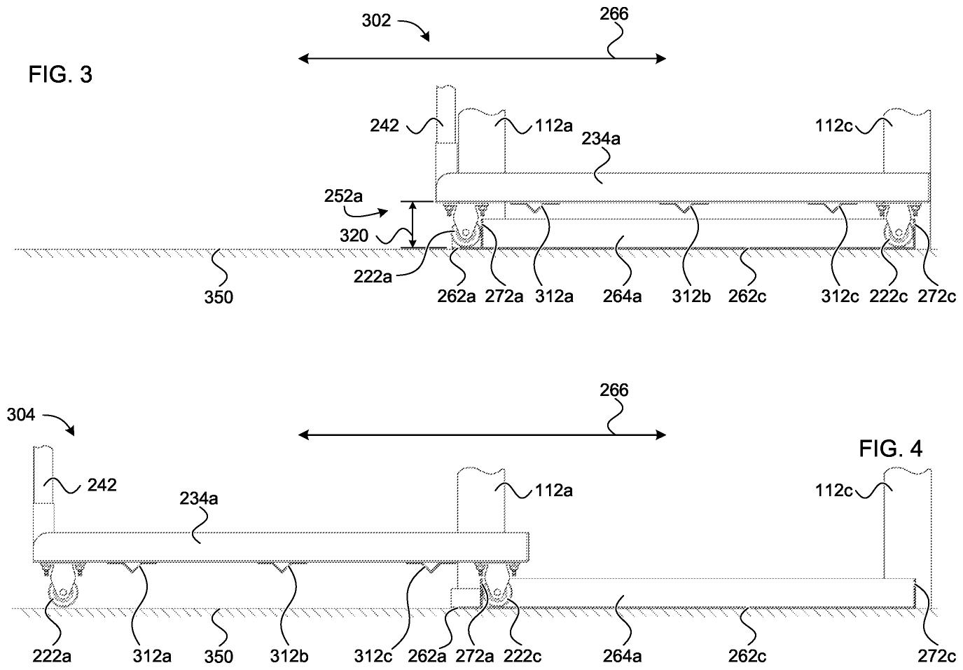

FIGS. 3 and 4 illustrate the example low profile storage cart 202 disposed in a storage state 302 and an access state 304. In the present example, the storage cart 202 can be disposed at any possession between the storage state 302 and the access state 304. Alternatively, the storage cart 202 or the rail 262c could be configured to urge the storage cart into either the storage state 302 or the access state 304.

In the present example, the top of the flat sheet 232 is disposed at a height 320 above the first rolling surface 262a and the third rolling surface 262c. In the present example, the height 320 is approximately 3 inches. In various other examples, the height 320 could be more or less than approximately 3 inches. For example, the casters 222a, 222b, 222c, 222d could have a diameter of approximately 2 inches or have a diameter of more than 4 inches. By adjusting the height of the casters 222a, 222b, 222c, 222d, the overall height of the 320 can be adjusted to fit different storage racks (e.g., storage rack 102 of FIG. 1). As a result, the height 320 could be as little as approximately 2.5 inches or more than 5 inches.

In the storage state 302, the storage cart 202 is disposed in the storage rack 102, and, more specifically, the example first floor storage 106. In the storage state 302 the caster 222a rests against the first rolling surface 262a and the first stop 272a. Additionally, the caster 222c rests against the rolling surface 262c and the stop 272c. As shown in the illustrated example, a length of the rolling surface 262c is equal to a distance between caster 222a and caster 222c. In other examples, the length and the distance may be different. In such examples, only one of the casters 222a or 222c may rest against the stops 272a or 272c, respectively.

In the access state 304, most of the storage cart 202 is disposed outside the first floor storage 106. Specifically, the caster 222a is disposed on a ground surface 350 and is no longer in contact with the rails 252a and the caster 222c is in contact with the stop 272a. The stop 272a inhibits the storage cart 202 from completely disconnecting from the securement mechanism 304 during normal operation of the storage cart 202. In the access state 304, a substantial portion of the flat sheet 232 is disposed outside the first floor storage 106 area. Additionally, in the access state 304, it is much easier to transfer a heavy bulky keg from storage to a dolly or cart. The person lifting the keg does not need to exert any force far away from their body but can bring the keg close to facilitate handling the large keg.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

What is claimed is:

1. A low-profile storage cart system for refrigerated storage systems, comprising:
a securement mechanism having a proximate end and a distal end, the securement mechanism further comprising:
at least one rail;
at least one rolling surface disposed the rail;
at least one guide surface disposed adjacent to the rolling surface; and
at least one stop disposed on the rolling surface; and
a low-profile storage cart comprising;
a carrying surface;
at least one wheel configured to engage the securement mechanism; and
a control arm disposed perpendicular to the carrying surface.

2. The low-profile storage cart system of claim 1, wherein the wheel is configured to engage the rolling surface.

3. The low-profile storage cart system of claim 1, wherein the guide surface is disposed perpendicular to the rolling surface from the proximate end to the distal end, the guide surface configured to retain the wheel on the rolling surface.

4. The low-profile storage cart system of claim 1, wherein the stop is disposed perpendicular to the rolling surface and configured to inhibit longitudinal movement of the wheel.

5. The low-profile storage cart system of claim 1, wherein the low-profile storage cart system includes a first rail and a second rail, the first rail including a first rolling surface and a first guide surface and the second rail including a second rolling surface and a second guide surface.

6. The low-profile storage cart system of claim 5, wherein the low-profile storage cart includes a first wheel configured to engage the first rolling surface and a second wheel configured to engage the second rolling surface.

7. A low-profile storage cart system for a refrigeration storage system, comprising:
a securement mechanism including a proximate end and a distal end, the securement mechanism including a first rail and a second rail; and
a low-profile storage cart including a carrying surface and at least one wheel configured to engage the securement mechanism.

8. The low-profile storage cart system of claim 7, wherein at least one of the first and second rails includes a rolling surface.

9. The low-profile storage cart system of claim 8, wherein the wheel is configured to engage the rolling surface.

10. The low-profile storage cart system of claim 9, wherein at least one of the first and second rails includes at least one stop.

11. The low-profile storage cart system of claim 10, wherein the rolling surface is disposed along a longitudinal axis, the stop disposed on the rolling surface and configured to inhibit the wheel from moving in a direction of the longitudinal axis.

12. The low-profile storage cart system of claim 10, wherein the rolling surface includes a first rolling surface and a second rolling surface, and the low-profile cart includes a first wheel and a second wheel; and
wherein the first wheel is disposed on the first rolling surface and the second wheel is disposed on the second rolling surface, the stop disposed between the first rolling surface and the second rolling surface.

13. The low-profile storage cart system of claim 8, wherein at least one of the first and second rails further includes a guide surface disposed adjacent to the rolling surface.

14. The low-profile storage cart system of claim 13, wherein the guide surface is parallel to the rolling surface.

15. The low-profile storage cart system of claim 7, wherein the low-profile storage cart includes a control arm.

16. The low-profile storage cart system of claim 15, wherein the low-profile storage cart includes a proximal end and a distal end, and the control arm is disposed on the proximal end.

17. The low-profile storage cart system of claim 15, wherein the control arm is perpendicular to the carrying surface.
